(19) United States
(12) Patent Application Publication
(10) Pub. No.: US 2026/0023399 A1
(43) Pub. Date: Jan. 22, 2026

(54) REAL-TIME ADVISORY SYSTEM AND METHOD FOR STEAM DISTRIBUTION NETWORK OPERATION

(71) Applicant: Saudi Arabian Oil Company, Dhahran (SA)

(72) Inventors: Mana M. Alowaidh, Dhahran (SA); Abdulaziz A. Al-Dulaijan, Al-Khobar (SA); Abdullah M. Al-Otaibi, Khobar City (SA); Ghadah T. Alamer, Dhahran (SA)

(21) Appl. No.: 18/779,464

(22) Filed: Jul. 22, 2024

(51) Int. Cl. G05D 7/06; G05D 9/12

(52) U.S. Cl. CPC G05D 7/0623; G05D 9/12

(57) ABSTRACT

A computer-implemented method includes obtaining plant steam data regarding a plurality of steam traps of an industrial plant implementing a steam distribution network during operation of the industrial plant. A database is developed using the plant steam data and used to develop a mathematical correlation that describes a condensation removal rate as a function of parameters including a type of steam trap, temperature, pressure, and a steam volumetric flow rate. A digital twin of the steam distribution network is developed using a machine-learning model and the mathematical correlation, where the digital twin represents all steam straps of the steam distribution network. During operation of the industrial plant, a trap condition of a steam trap of the digital twin is estimated based on a set of plant steam data regarding the plurality of steam traps of the industrial plant.

### TECHNICAL FIELD

This disclosure relates to real-time advisory system and method for steam distribution network operation.

### BACKGROUND

Steam is used in various applications in many plant facilities, such as in heating and power generation operations. In particular, steam may be sent throughout a plant over a steam distribution network from various boilers, where the steam becomes condensate that is returned to the boilers over a return network. The steam distribution network may include multiple steam traps for removing condensate from the steam network, while having the steam network continue to perform various steam operations. To prevent or minimize malfunction of steam traps, it may be necessary to accurately monitor the operation of the steam distribution network.

### SUMMARY

This disclosure describes technologies relating to a real-time advisory system and method for steam distribution network operation.

An implementation described herein provides a computer-implemented method including: obtaining plant steam data regarding a plurality of steam traps of an industrial plant implementing a steam distribution network during operation of the industrial plant, the plant steam data including a type of steam trap, temperature, pressure, steam volumetric flow rate, condensate accumulation, condensate removal rate, and trap condition at each of the plurality of steam traps, the trap condition including information regarding whether the condensate accumulation is below a predetermined threshold value for the type of steam trap; developing a database using the plant steam data; using the database, developing a mathematical correlation that describes the condensation removal rate as a function of parameters including the type of steam trap, the temperature, the pressure, and the steam volumetric flow rate; developing a digital twin of the steam distribution network using a machine-learning model and the mathematical correlation, the digital twin representing all steam straps of the steam distribution network; and estimating, during the operation of the industrial plant, a trap condition of a steam trap of the digital twin based on a set of plant steam data regarding the plurality of steam traps of the industrial plant.

In an aspect, combinable with any other aspect, the steam trap of the digital twin corresponds to one of the plurality of steam traps of the industrial plant.

In an aspect, combinable with any other aspect, the computer-implemented method further includes validating the trap condition estimated for the digital twin with the trap condition of the one of the plurality of steam traps.

In an aspect, the computer-implemented method further includes, if a discrepancy between the condensate accumulation estimated in the digital twin and that of the industrial plant is 3% or greater, repeating the steps of obtaining the plant steam data, developing the database, and developing the mathematical correlation to update the digital twin.

In an aspect, combinable with any other aspect, the steam trap of the digital twin corresponds to another steam trap of the industrial plant, the another steam trap being not among the plurality of steam traps of the industrial plant.

In an aspect, combinable with any other aspect, the computer-implemented method further includes, if the trap condition of the steam trap of the digital twin is estimated to indicate the condensate accumulation is above the predetermined threshold value, sending an alert to an operator of the industrial plant.

In an aspect, combinable with any other aspect, the plurality of steam traps accounts for from 20% to 30% of a total number of steam traps of the steam distribution network.

In an aspect, combinable with any other aspect, the computer-implemented method further includes, estimating trap conditions of all steam traps of the digital twin.

In an aspect, combinable with any other aspect, the type of steam trap is characterized by a volume, a mechanical design, a structural material, and a maximum condensate removal rate.

In an aspect, combinable with any other aspect, the computer-implemented method further includes, predicting a future trap condition of a steam trap of the digital twin based on a set of plant steam data regarding the plurality of steam traps of the industrial plant.

In an aspect, predicting the future trap condition includes estimating a time when the condensate accumulation reaches the predetermined threshold value.

An implementation described herein provides a non-transitory computer-readable medium storing instructions executable by a computer processor, where the instructions include functionality for: obtaining plant steam data regarding a plurality of steam traps of an industrial plant implementing a steam distribution network, the plant steam data including a type of steam trap, temperature, pressure, steam volumetric flow rate, condensate accumulation, condensate removal rate, and trap condition at each of the plurality of steam traps, the trap condition including information regarding whether the condensate accumulation is below a predetermined threshold value for the type of steam trap; developing a database using the plant steam data; using the database, developing a mathematical correlation that describes the condensation removal rate as a function of parameters including the type of steam trap, the temperature, the pressure, and the steam volumetric flow rate; developing a digital twin of the steam distribution network using a machine-learning model and the mathematical correlation; and estimating a trap condition of a steam trap of the digital twin based on a set of plant steam data regarding the plurality of steam traps of the industrial plant.

In an aspect, combinable with any other aspect, the instructions further include functionality for transmitting a command that adjusts one or more parameters of the steam distribution network based on the trap condition of the steam strap of the digital twin.

In an aspect, combinable with any other aspect, determining the trap condition of the steam trap of the digital twin includes classifying the trap condition of the steam trap of the digital twin into one of a plurality of categories, each category representing a different level of the condensate accumulation in the steam trap.

In an aspect, combinable with any other aspect, the instructions further include estimating a steam quality at a steam header of the steam distribution network using the digital twin and the plant steam data.

An implementation described herein provides a computer-implemented system including: a steam generator; a steam header coupled to the steam generator; a steam trap including an inlet and an outlet, the inlet being coupled to the steam header; and a steam trap manager coupled to the steam trap, the steam trap manager including a computer processor and a machine-learning model, the computer processor including a non-transitory computer readable medium storing instructions to: obtain a series of steam trap data including a type of the steam trap, temperature, pressure, steam volumetric flow rate, condensate accumulation, condensate removal rate, and trap condition of the steam trap, the trap condition including information regarding whether the condensate accumulation is below a predetermined threshold value for the type of the steam trap; develop a database from the series of steam trap data; using the database, develop a mathematical correlation between the condensation removal rate and one or more of the type of steam strap, the temperature, the pressure, and the steam volumetric flow rate; develop a digital twin of the steam trap using a machine-learning model and the mathematical correlation; and estimate a trap condition of the steam trap of the digital twin for a set of steam trap data.

In an aspect, combinable with any other aspect, the non-transitory computer readable medium stores a further instruction to adjust one or more parameters for operating the system based on the estimated trap condition of the steam trap.

In an aspect, combinable with any other aspect, the non-transitory computer readable medium stores further instructions to, after adjusting the one or more parameters, repeat the steps of obtaining the series of steam trap data, developing the database, developing the mathematical correlation, developing the digital twin, and estimating the trap condition.

In an aspect, combinable with any other aspect, the non-transitory computer readable medium stores a further instruction to estimate a steam quality at the steam header using the digital twin and the series of steam trap data.

In an aspect, combinable with any other aspect, the predetermined threshold value is from 40% to 60% of a volumetric capacity of the steam trap.

### BRIEF DESCRIPTION OF DRAWINGS

FIG. 1 is a schematic representation of an industrial plant implementing a steam distribution network, according to an implementation of the present disclosure.

FIG. 2 is a workflow illustrating procedures to quantify condensation rate and condensation removal rate from steam traps, according to an implementation of the present disclosure.

FIG. 3 is a mathematical representation of the workflow of FIG. 2, according to an implementation of the present disclosure.

FIG. 4 is a workflow illustrating a condensate removal rate estimation procedure using a machine-learning model, according to an implementation of the present disclosure.

FIG. 5 is a process flow diagram of a method of estimating a steam trap condition using the machine-learning model, according to an implementation of the present disclosure.

FIG. 6 is a block diagram illustrating an example of a computer-implemented system used to provide computational functionalities associated with described algorithms, methods, functions, processes, flows, and procedures, according to an implementation of the present disclosure.

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Like reference numbers and designations in the various drawings indicate like elements.

### DETAILED DESCRIPTION

The following detailed description describes a real-time advisory system and method for an industrial steam distribution system and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

More specifically, the system can accurately estimate or predict the level of condensate accumulation by each steam trap of the steam distribution system using real time data such as temperature, pressure, and steam volumetric flow rate as well as thermodynamic representation/correlation of each steam trap. This estimation or prediction of condensate accumulation can be used to provide information on individual and overall steam trap conditions. In various implementations, the accuracy of estimation and prediction can be further improved with continuous live monitoring of the steam distribution system.

With the ability of real-time monitoring of the steam traps, the system also can provide a proactive advisory warning to an operator of the steam distribution system to avoid steam hammering. The proactive warning can also include sending a command to automatically adjust one or more of the process parameters for operating the steam distribution system to prevent any abnormal events. Further, the system can be configured to automatically adjust and control one ore more of equipment of the steam distribution network, e.g., steam generators, valves, steam traps, and pumps, in response to the output from the system. In various implementations, the system uses a machine-learning model and mathematical correlations to develop a digital twin that achieves the best representation of steam trap performance according to steam trap type, size, and operating conditions.

In various implementations, the advisory system can use the monitored data of a fraction, e.g., about 20-30%, of the total steam trap populations in the steam distribution system and extrapolate them using the digital twin to estimate trap conditions of the remainder of the steam traps, e.g., 70-80% of the total steam trap populations. Accordingly, the methods can case process equipment monitoring around a plant facility by reducing time required to inspect steam traps. Further, the methods can also minimize plant losses from malfunctioning steam equipment through early detection and identification of early failure conditions through an autonomous workflow.

In contrast, conventional systems and methods often detect these issues only after their occurrence and, therefore, addresses them reactively. Rather than relying on inconsistent results based on human inspections, machine learning can provide an objective, reliable, and effective indicator of changing plant conditions for use in managing maintenance operations.

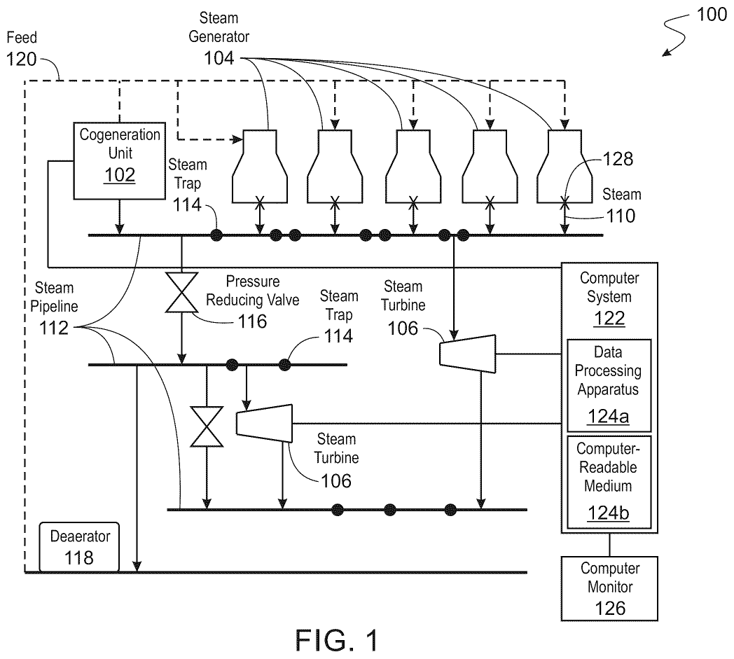

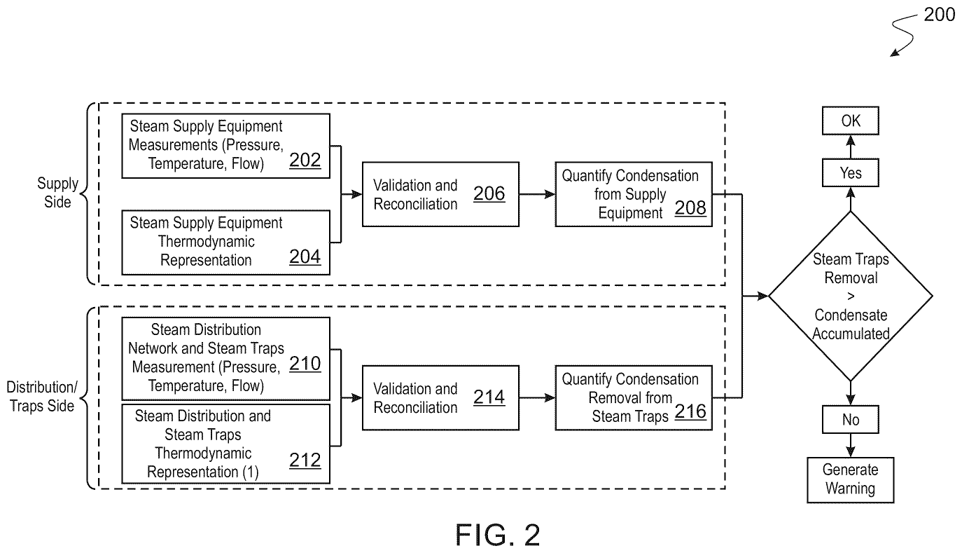

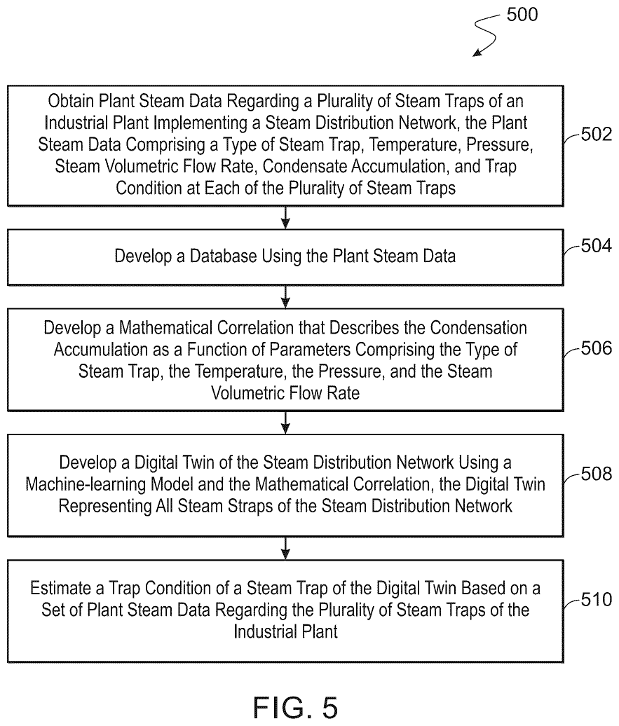

Referring to FIG. 1, an example industrial plant implementing a steam distribution network is described. methods of steam trap monitoring using a machine-learning model are then described referring to FIGS. 2-4. A process flow diagram of a method of estimating a steam trap condition in accordance with an implementation is provided in FIG. 5.

### A Steam Distribution System of an Industrial Plant

FIG. 1 is a schematic representation of an industrial plant implementing a steam distribution network 100, according to an implementation of the present disclosure. In various implementations, the steam distribution network 100 is a part of, or includes an industrial steam power and utility system that operates multiple equipment including, for example, a cogeneration unit 102, steam generators 104 such as boilers, steam turbines 106 and others. The design and configuration of the steam distribution network 100 illustrated in FIG. 1 is for example and other designs with other elements are possible.

Each piece of equipment of the steam distribution network 100 implements a process or processes, e.g., cogenerating power and heat at the cogeneration unit 102, generating steam 110 using heat at the steam generators 104, generating power at the steam turbines 106, and delivering steam through steam pipelines 112 to various equipment that uses the steam 110.

Further, as illustrated in FIG. 1 as solid dots, the steam distribution network 100 can include one or more steam traps 114. For example, a steam trap may include hardware that acts as a draining element within a steam system. As such, a steam trap may cause an abrupt change in pressure from an inlet to an outlet, while maintaining the steam's energetic content. In particular, a mixture of condensate and steam may be provided at a steam trap's inlet, where the steam trap removes the condensate that is passed through the outlet, such as to a condensate return line. Likewise, the removed condensate may be partially re-vaporized within the steam trap in order to reach an energy balance, e.g., based on the expansion of the condensate through the steam trap since no external heat may be provided. Different types of steam traps can be used, such as a passive stream trap, a steam energy trap, and an intelligent steam trap. After condensate passes through a steam trap, a condensate may be transported over a condensate return network using various return lines. For example, the condensate may be returned to one or more steam generators 104 for use in producing more steam for various steam applications. For illustration purposes, the return lines are omitted in FIG. 1.

A total number of the steam traps 114 and their locations can depend on a type of facility. For example, in some implementations, from about 100 to about 5000 steam traps can be used.

In various implementations, the real-time advisory method described in this disclosure includes monitoring one or more steam traps 114 and determine conditions of not only the monitored steam traps but also other steam traps that are not directly monitored. This extrapolation can be enabled by developing a mathematical correlation between the condensate removal rate of each steam trap and the monitored parameters, e.g., trap type, temperature, steam flow rate, and condensate accumulation, using a machine-learning model. For example, the advisory system can use about 20-30%, of the total steam trap populations in the steam distribution system to estimate trap conditions of the remainder of the steam traps, e.g., 70-80% of the total steam trap populations. Further, as well as the assessment of individual steam traps, the methods allow the estimation of the overall assessment of operation of the steam traps as a whole. In some implementations, the methods include predicting a trap condition based on historical data, which can be used to evaluate steam hammering risk potentials.

While implementing the process or processes, each piece of equipment outputs an operational physical parameter value. For example, the operational physical parameter can include temperature, pressure, steam flow rate or similar parameters experienced by the equipment. The operational physical parameter is a value representative of the corresponding parameter, e.g., a temperature value, a pressure value, a flow rate value. Accordingly, although not specifically illustrated in FIG. 1, multiple sensors can be operatively coupled to each piece of equipment to measure the operational physical parameters. The sensors, e.g., thermocouple to sense a temperature value, pressure gauge to sense a pressure value, and flow meter to sense a flow rate value, can transform the sensed physical parameters into digital signals, and transmit the signals to a destination.

In various implementations, the steam distribution network 100 can be configured to provide the steams 110 at various pressures. For example, as illustrated in FIG. 1, three different levels of pressure, e.g., high pressure, medium pressure, and low pressure, can be provided through multiple sets of the steam pipelines 112. The steam distribution network 100 can accordingly include one or more pressure reducing valves 116 between the different pressure levels as well as a deaerator 118 to remove dissolved gases from the final condensate before returning the treated final condensate back to the steam generators 104 as feed 120.

Further, different types of steam can be used in various applications and processes within the steam distribution network 100. For example, dry saturated steam can include steam at a boiling temperature without any water particles in liquid form in the steam. Steam can be changed into water during a condensation process that is the inverse process of vaporization. During a re-vaporization process, vapor can be formed as a result of a drop in pressure or the expansion of condensate. Thus, re-vaporized steam may also be referred to as “expansion steam” or “flash steam.”

In various implementations, the steam distribution network 100 is operatively coupled to a computer system 122 that includes one or more data processing apparatus 124 a, e.g., one or more data processors, and a computer-readable medium 124 b, e.g., a non-transitory computer-readable medium, storing computer instructions executable by the one or more data processing apparatus 124 a to perform the operations described here. For each piece of equipment in the steam distribution network 100, the computer system 122 receives operational physical parameter values measured by sensors mounted on the equipment during operation of the equipment. For example, the computer system 122 receives the digital signals representing sensed operational physical parameter values measured by the sensors. The computer system 122 can store the received signals to implement the processing described below. For illustration purpose, some connections between the computer system 122 and equipment such as sensors are omitted in FIG. 1.

In some implementations, the computer system 122 can use the received operational physical parameter values to determine mass balance and energy balance parameters associated with the equipment from which the operational physical parameter values were received. These determined mass balance and energy balance can be used to estimate condensation formation rate at various points in the steam distribution network 100. As further described below, in various implementations, the computer system 122 is configured to collect data, develop a database, develop a mathematical correlation for condensate removal rate estimation, and develop a digital twin for trap condition estimation.

In various implementations, the steam distribution network 100 includes a steam trap manager, which can be integrated in the computer system 122. The steam trap manager can include hardware and software with functionality for monitoring one or more steam traps in the steam distribution network 100. Further, the steam trap manager can include functionality for determining a state of a steam trap using one or more machine-learning models. For example, a steam trap manager can use various machine-learning techniques to classify the status of a particular steam trap by deducing physical phenomena using various temperature values and other data, e.g., the type of steam trap, pressure, steam volumetric flow rate, and the condensate removal rate.

In some implementations, the computer system 122 is operatively coupled to a computer monitor 126. Real-time outputs of the determination and validation operations for steam traps can be displayed on the computer monitor 126. For example, an alert can be displayed in the computer monitor 126 when the method determines that the condensate accumulation in one of the steam traps 114 reaches a predetermined threshold value.

In some implementations, the steam distribution network 100 can include one or more closed pipe circuits where water changes to steam then back to water again, thereby repeating this cycle without losing water mass. In another implementation, the steam distribution network 100 can include one or more open pipe circuits where condensate produced from steam is not sent back to a steam generator, but instead evacuated outside a plant facility.

Furthermore, the steam distribution network 100 can also include one or more steam headers 128. A steam header can function as a distribution manifold that collects the steam 110 from one or multiple steam generators 104 and distributes it to the steam pipelines 112 leading to different parts of the network. Thus, steam headers may serve as a reservoir that feed steam to individual heating circuits or other steam application circuits. As such, steam headers may be large enough to reduce pressure drops between the steam generators 104 and the beginning of a steam application circuit. In contrast, steam pipes that are undersized may cause high pressure drops resulting in steam starvation at the point of usage. The methods can be used to estimate or predict condensate accumulation at or near the steam headers 128.

### Types of Steam Trap

In various implementations, different types of steam traps can be used in the steam distribution network 100, and the real-time advisory system and method in this disclosure can account for the characteristics of different types of steam traps. The type of steam trap can be characterized by, for example, a size, volume, mechanical design, structural material, and maximum condensate removal rate. Examples of steam traps include a passive steam trap, thermostatic steam trap and mechanical steam trap.

A passive steam trap includes various types of steam traps, such as cyclic and continuous steam traps, orifice plate steam traps, float traps, inverted bucket traps, thermodynamic steam traps, thermostatic steam traps, and mechanical steam traps.

A thermostatic steam trap can operate in response to the surrounding steam temperature. Temperature in a thermostatic steam trap can be adjusted, such as using an external adjustment mechanism. Examples of thermostatic steam traps can include liquid expansion traps, bimetallic steam traps, and balanced pressure steam trap.

A mechanical steam trap can operate based on the difference in density between steam and condensate. Examples of mechanical steam traps can include ball float steam traps and inverted bucket steam traps.

### Process of Steam Supply and Steam Trap Monitoring

FIG. 2 is a workflow 200 illustrating procedures to quantify condensation rate and condensation removal rate from steam traps, according to an implementation of the present disclosure.

Condensation of the steam back to water may occur in the steam distribution network 100, and the condensate, if not properly removed from the steam, may degrade the steam quality and cause steam hammering. These events are undesirable in the steam distribution network 100 because they can harm the equipment and lower the process efficiency. In various implementations, the real-time advisory method can eliminate or reduce these risks by accurately estimating steam trap conditions.

The trap condition can be estimated by comparing the condensation removal rate at a given steam trap with the condensation rate in the steam trap. When the removal rate is greater than the condensation rate, the trap condition can be determined to be healthy, and no operational action may be needed. On the other hand, when the removal rate is less than the condensation rate, the real-time advisory system can generate and transmit a warning to an operator of the steam distribution network 100.

In some implementations, other criteria for the trap condition estimation can be used. For example, a warning can be sent when the estimated condensate accumulation is above a predetermined threshold value for the steam trap. In some implementations, the threshold value can be set from 40% to 60% of a volumetric capacity of the steam trap, e.g., about 50%. To determine the trap condition, the condensate rate can be estimated from the steam supply side of the steam distribution network 100 and the condensation removal rate can be estimated based on information collected from the steam traps.

At the steam supply side, steam supply equipment measurements (step 202) can be performed for data collection of physical parameters such as pressure, temperature, steam flow rates from equipment, e.g., the steam generators 104 in FIG. 1. Subsequently, the received data can be used to determine mass balance and energy balance parameters associated with the equipment (step 204) and the operation of equipment can be validated (step 206) using the determined mass balance and energy balance parameters. Such validation can include comparing the mass balance and energy balance parameters determined for the equipment against threshold mass balance and energy balance parameters.

If the results of the comparison reveal that the threshold parameters are satisfied, the operation of the equipment is validated as being satisfactory. To the contrary, if the results reveal that the threshold parameters are not satisfied, the operation of the equipment is validated as being unsatisfactory. In such cases, one or more process parameters on the steam supply side can be adjusted for better operation (reconciliation in step 206). Using the determined mass balance and energy balance parameters determined for the steam supply side, condensation rate in the steam distribution network 100 can be estimated (step 208).

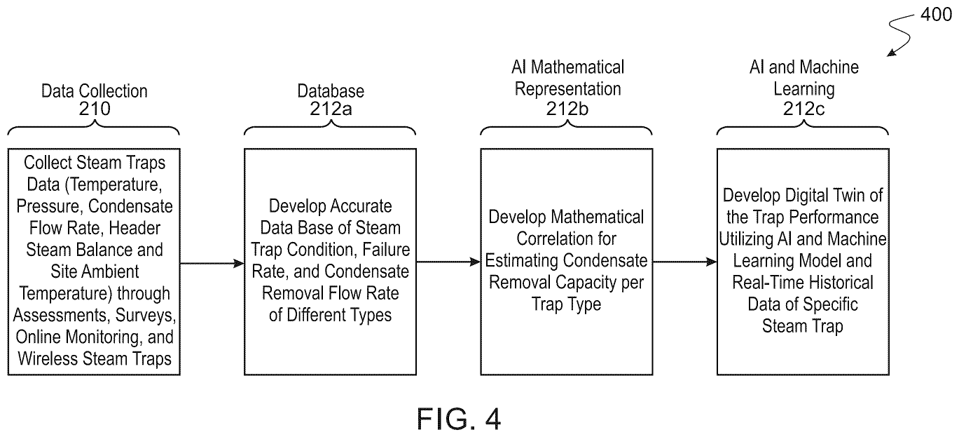

At the steam trap side, steam distribution equipment measurements (step 210) can be performed for data collection of physical parameters such as pressure, temperature, steam flow rates, condensate flow rate from equipment, e.g., the steam traps 114 in FIG. 1. The physical parameters can also include header steam balance and site ambient temperature. Data collection can be performed by, for example, assessments, surveys, and online and/or wireless steam trap monitoring. Subsequently, the received data can be used to perform a series of steps to develop a digital twin using one or more machine-learning models (step 212), which will be further described below referring to FIG. 4. The accuracy of the digital twin can be validated (step 214) by comparing predicted values from the digital twin with a renewed set of measured physical parameters and ensuring their discrepancy is within an acceptable error range, e.g., 3% or less. Using the digital twin and the measured physical parameters for steam distribution equipment, condensation removal rate in the steam distribution network 100 can be estimated (step 216).

In various implementations, real-time monitoring cover from 20 to 30% of the total steam trap population, and the correlation fit can be adjusted for the remaining steam traps, e.g., from 70% to 80%. In one or more implementations, the measured physical parameters such as temperature and steam flow rate for each of the remaining steam traps can be used as input for the estimation of conditions of their corresponding steam straps using the digital twin. In some implementations, the method further includes an algorithm to determine which input to use to generate the most accurate estimation result.

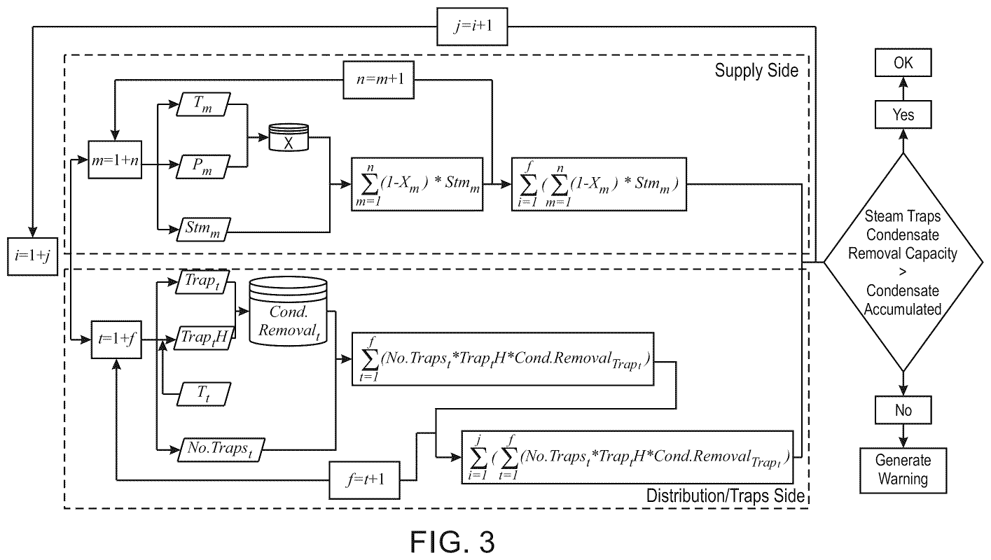

FIG. 3 is a mathematical representation of the workflow 200 of FIG. 2, according to an implementation of the present disclosure. In FIG. 3 i is the counter for a header segment; m is the counter for an equipment producing steam to a header segment i; Tₘ is the steam temperature; Pₘ is the steam pressure; Stmₘ is the steam volumetric flow rate; Xₘ is the steam quality; Trapₜ is the steam trap type; No. Trapsₜ is the number of steam traps; TrapₜH is the trap healthiness according to a recent study or online measurement; Tₜ is the local temperature reading at trap, e.g., actual, gauge, online, offline, and/or study; and Cond. Removal_{Trap} is the calculated parameter of condensate removal percentage by steam traps according to healthiness matrix. The healthiness matrix can be a reference dataset used to represent the level of healthiness of a steam trap. In some implementations, the healthiness matrix for each steam trap type can be obtained from the condensate removal rate based on the design data sheet of each steam trap type for a healthy condition. Further, from historical detailed assessments conducted by specialized vendors, quantified value of condensate removal according to failure type per steam trap can also be estimated. These data can be used in combination to provide a representation of steam trap.

In some implementations, the formula for the condensate removal rate is described as below:
Condensate removal rate=ax^{m}+byⁿ+cz^{g}+df^{k}
   where x is the type of steam trap, y is the steam trap volume (lb/h), z is the steam trap live temperature (F), the f is historical performance and condition of steam trap (unit less); and a, b, c, and d are their coefficients, respectively. Using one or more machine-learning models, the initial formula can be optimized to achieve the best fit with the available data set.

In various implementations, the process for estimating trap conditions is performed as a cyclic process by cyclically repeating the steps described above such that the monitoring and process assessment regarding the steam traps 114 continues for the duration of the operation of the steam distribution network 100.

### Use of Machine-Learning Model for Developing a Digital Twin

FIG. 4 is a workflow 400 illustrating a condensate removal rate estimation procedure using a machine-learning model, according to an implementation of the present disclosure. FIG. 4 corresponds to steps 211 and 212 in FIG. 2. Step 211 follows as described above referring to FIG. 2. After the data collection, the workflow 400 can proceed to developing a database (step 212a) from the collected data, which can include, for example, historical steam trap conditions, failure rate, and condensate removal rate for different types of steam trap.

In various implementations, a steam trap condition is characterized by classifying the steam trap according to one or more states. Examples of steam trap states may include a healthy state, e.g., where a steam trap's inlet is at a high temperature since steam is trapped at the inlet while the steam trap's outlet is condensate at a cold temperature. In a healthy state, a steam trap may allow condensate to pass through while trapping the steam at the inlet. Another state of a steam trap may correspond to a passing state, where the trap's inlet and outlet temperatures are both high and close in value. In a passing state, a steam trap may continue to blow steam through the trap indicating the trap is functioning at some level. Another state of a steam trap may correspond to a blocked state, where the trap's inlet and outlet temperatures are both low and close in value. In a blocked state, a steam trap may have no condensate passing through the trap indicating failed position, e.g., closed position, of the steam trap.

After developing the database (step 212a), using the database, the workflow 400 proceeds to step 212b of developing a mathematical correlation that describes the condensation removal rate as a function of parameters such as the type of steam trap, the temperature, the pressure, and the steam volumetric flow rate. Subsequently, in step 212c, a digital twin of the steam distribution network 100 including the steam traps 114 can be developed using one or more machine-learning models and the mathematical correlation from step 212b. This process can include optimizing the mathematical correlation to achieve the best fit with the collected data. In various implementations, the machine-learning model can be included in the steam trap manager.

Further, different types of machine-learning models can be trained, such as convolutional neural networks, deep neural networks, recurrent neural networks, support vector machines, decision trees, inductive learning models, deductive learning models, supervised learning models, unsupervised learning models, and reinforcement learning models. In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network.

FIG. 5 is a process flow diagram of a computer-implemented method 500 of estimating a steam trap condition using the machine-learning model, according to an implementation of the present disclosure. For clarity of presentation, the description that follows generally describes method 500 in the context of the other figures in this description. However, it will be understood that method 500 can be performed, for example, by any system, environment, software, and hardware, or a combination of systems, environments, software, and hardware, as appropriate. In some implementations, various steps of method 500 can be run in parallel, in combination, in loops, or in any order.

At step 502, plant steam data regarding a plurality of steam traps of an industrial plant implementing a steam distribution network is obtained during operation of the industrial plant. In various implementations, the plant steam data includes a type of steam trap, temperature, pressure, steam volumetric flow rate, condensate accumulation, condensate removal rate, and trap condition at each of the plurality of steam traps, and the trap condition includes information regarding whether the condensate accumulation is below a predetermined threshold value for the type of steam trap. From step 502, method 500 proceeds to step 504.

At step 504, a database is developed using the plant steam data. From step 504, method 500 proceeds to step 506.

At step 506, using the database, a mathematical correlation is developed that describes the condensation removal rate as a function of parameters including the type of steam trap, the temperature, the pressure, and the steam volumetric flow rate. From step 506, method 500 proceeds to step 508.

At step 508, a digital twin of the steam distribution network is developed using a machine-learning model and the mathematical correlation, where the digital twin represents all steam straps of the steam distribution network. From step 508, method 500 proceeds to step 510.

At step 510, during the operation of the industrial plant, a trap condition of a steam trap of the digital twin is estimated based on a set of plant steam data regarding the plurality of steam traps of the industrial plant.

As described above, the real-time advisory systems and methods can estimate or predict steam trap data regarding one or more steam traps throughout a plant facility implementing a steam distribution network. One or more machine-learning models can be used to develop a digital twin for estimating condensate removed from each steam trap via real-time historical data analytic system. Examples of predicted steam trap data can include the health of a respective steam trap, e.g., whether the steam trap is operating satisfactorily, is partially blocked, or is completely blocked, or an expected failure date of a particular steam trap. The real-time systems can accordingly identify potential risk for steam hammering and condensate accumulation. In some implementations, an alert can be sent to the plant's operator when condensate level accumulation at the header was increased compared to the historical trend and benchmark the value with steam traps condensate removal quantity. The system can also be used to identify the best locations of steam traps during design stage and to assess existing design and identify areas for improvements.

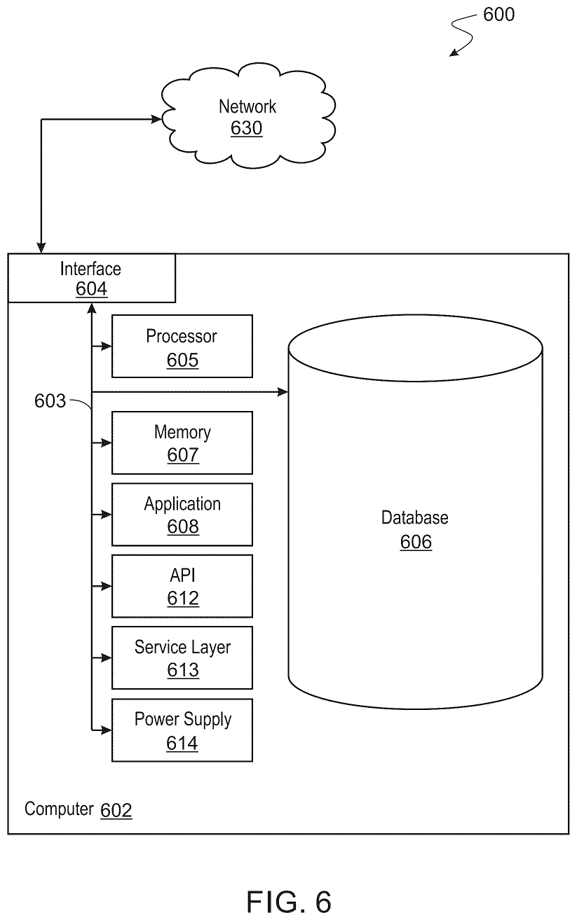

FIG. 6 is a block diagram illustrating an example of a computer-implemented System 600 used to provide computational functionalities associated with described algorithms, methods, functions, processes, flows, and procedures, according to an implementation of the present disclosure. In the illustrated implementation, computer-implemented system 600 includes a Computer 602 and a Network 630.

The illustrated Computer 602 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 602 can include an input device, such as a keypad, keyboard, or touch screen, or a combination of input devices that can accept user information, and an output device that conveys information associated with the operation of the Computer 602, including digital data, visual, audio, another type of information, or a combination of types of information, on a graphical-type user interface (UI) (or GUI) or other UI.

The Computer 602 can serve in a role in a distributed computing system as, for example, a client, network component, a server, or a database or another persistency, or a combination of roles for performing the subject matter described in the present disclosure. The illustrated Computer 602 is communicably coupled with a Network 630. In some implementations, one or more components of the Computer 602 can be configured to operate within an environment, or a combination of environments, including cloud-computing, local, or global.

At a high level, the Computer 602 is an electronic computing device operable to receive, transmit, process, store, or manage data and information associated with the described subject matter. According to some implementations, the Computer 602 can also include or be communicably coupled with a server, such as an application server, e-mail server, web server, caching server, or streaming data server, or a combination of servers.

The Computer 602 can receive requests over Network 630 (for example, from a client software application executing on another Computer 602) and respond to the received requests by processing the received requests using a software application or a combination of software applications. In addition, requests can also be sent to the Computer 602 from internal users (for example, from a command console or by another internal access method), external or third-parties, or other entities, individuals, systems, or computers.

Each of the components of the Computer 602 can communicate using a System Bus 603. In some implementations, any or all of the components of the Computer 602, including hardware, software, or a combination of hardware and software, can interface over the System Bus 603 using an application programming interface (API) 612, a Service Layer 613, or a combination of the API 612 and Service Layer 613. The API 612 can include specifications for routines, data structures, and object classes. The API 612 can be either computer-language independent or dependent and refer to a complete interface, a single function, or even a set of APIs. The Service Layer 613 provides software services to the Computer 602 or other components (whether illustrated or not) that are communicably coupled to the Computer 602. The functionality of the Computer 602 can be accessible for all service consumers using the Service Layer 613. Software services, such as those provided by the Service Layer 613, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 602, alternative implementations can illustrate the API 612 or the Service Layer 613 as stand-alone components in relation to other components of the Computer 602 or other components (whether illustrated or not) that are communicably coupled to the Computer 602. Moreover, any or all parts of the API 612 or the Service Layer 613 can be implemented as a child or a sub-module of another software module, enterprise application, or hardware module without departing from the scope of the present disclosure.

The Computer 602 includes an Interface 604. Although illustrated as a single Interface 604, two or more Interfaces 604 can be used according to particular needs, desires, or particular implementations of the Computer 602. The Interface 604 is used by the Computer 602 for communicating with another computing system (whether illustrated or not) that is communicatively linked to the Network 630 in a distributed environment. Generally, the Interface 604 is operable to communicate with the Network 630 and includes logic encoded in software, hardware, or a combination of software and hardware. More specifically, the Interface 604 can include software supporting one or more communication protocols associated with communications such that the Network 630 or hardware of Interface 604 is operable to communicate physical signals within and outside of the illustrated Computer 602.

The Computer 602 includes a Processor 605. Although illustrated as a single Processor 605, two or more Processors 605 can be used according to particular needs, desires, or particular implementations of the Computer 602. Generally, the Processor 605 executes instructions and manipulates data to perform the operations of the Computer 602 and any algorithms, methods, functions, processes, flows, and procedures as described in the present disclosure.

The Computer 602 also includes a Database 606 that can hold data for the Computer 602, another component communicatively linked to the Network 630 (whether illustrated or not), or a combination of the Computer 602 and another component. For example, Database 606 can be an in-memory or conventional database storing data consistent with the present disclosure. In some implementations, Database 606 can be a combination of two or more different database types (for example, a hybrid in-memory and conventional database) according to particular needs, desires, or particular implementations of the Computer 602 and the described functionality. Although illustrated as a single Database 606, two or more databases of similar or differing types can be used according to particular needs, desires, or particular implementations of the Computer 602 and the described functionality. While Database 606 is illustrated as an integral component of the Computer 602, in alternative implementations, Database 606 can be external to the Computer 602. The Database 606 can hold and operate on at least any data type mentioned or any data type consistent with this disclosure.

The Computer 602 also includes a Memory 607 that can hold data for the Computer 602, another component or components communicatively linked to the Network 630 (whether illustrated or not), or a combination of the Computer 602 and another component. Memory 607 can store any data consistent with the present disclosure. In some implementations, Memory 607 can be a combination of two or more different types of memory (for example, a combination of semiconductor and magnetic storage) according to particular needs, desires, or particular implementations of the Computer 602 and the described functionality. Although illustrated as a single Memory 607, two or more Memories 607 or similar or differing types can be used according to particular needs, desires, or particular implementations of the Computer 602 and the described functionality. While Memory 607 is illustrated as an integral component of the Computer 602, in alternative implementations, Memory 607 can be external to the Computer 602.

The Application 608 is an algorithmic software engine providing functionality according to particular needs, desires, or particular implementations of the Computer 602, particularly with respect to functionality described in the present disclosure. For example, Application 608 can serve as one or more components, modules, or applications. Further, although illustrated as a single Application 608, the Application 608 can be implemented as multiple Applications 608 on the Computer 602. In addition, although illustrated as integral to the Computer 602, in alternative implementations, the Application 608 can be external to the Computer 602.

The Computer 602 can also include a Power Supply 614. The Power Supply 614 can include a rechargeable or non-rechargeable battery that can be configured to be either user-or non-user-replaceable. In some implementations, the Power Supply 614 can include power-conversion or management circuits (including recharging, standby, or another power management functionality). In some implementations, the Power Supply 614 can include a power plug to allow the Computer 602 to be plugged into a wall socket or another power source to, for example, power the Computer 602 or recharge a rechargeable battery.

There can be any number of Computers 602 associated with, or external to, a computer system containing Computer 602, each Computer 602 communicating over Network 630. Further, the term “client,” “user,” or other appropriate terminology can be used interchangeably, as appropriate, without departing from the scope of the present disclosure. Moreover, the present disclosure contemplates that many users can use one Computer 602, or that one user can use multiple computers.

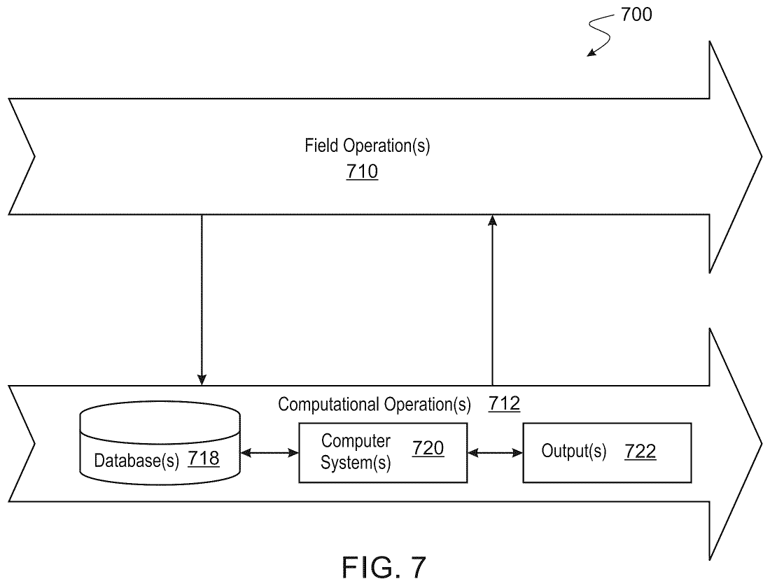

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively, or in addition to, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

### Implementations

An implementation described herein provides a computer-implemented method including: obtaining plant steam data regarding a plurality of steam traps of an industrial plant implementing a steam distribution network during operation of the industrial plant, the plant steam data including a type of steam trap, temperature, pressure, steam volumetric flow rate, condensate accumulation, condensate removal rate, and trap condition at each of the plurality of steam traps, the trap condition including information regarding whether the condensate accumulation is below a predetermined threshold value for the type of steam trap; developing a database using the plant steam data; using the database, developing a mathematical correlation that describes the condensation removal rate as a function of parameters including the type of steam trap, the temperature, the pressure, and the steam volumetric flow rate; developing a digital twin of the steam distribution network using a machine-learning model and the mathematical correlation, the digital twin representing all steam straps of the steam distribution network; and estimating, during the operation of the industrial plant, a trap condition of a steam trap of the digital twin based on a set of plant steam data regarding the plurality of steam traps of the industrial plant.

In an aspect, combinable with any other aspect, the steam trap of the digital twin corresponds to one of the plurality of steam traps of the industrial plant.

In an aspect, combinable with any other aspect, the computer-implemented method further includes validating the trap condition estimated for the digital twin with the trap condition of the one of the plurality of steam traps.

In an aspect, the computer-implemented method further includes, if a discrepancy between the condensate accumulation estimated in the digital twin and that of the industrial plant is 3% or greater, repeating the steps of obtaining the plant steam data, developing the database, and developing the mathematical correlation to update the digital twin.

In an aspect, combinable with any other aspect, the steam trap of the digital twin corresponds to another steam trap of the industrial plant, the another steam trap being not among the plurality of steam traps of the industrial plant.

In an aspect, combinable with any other aspect, the computer-implemented method further includes, if the trap condition of the steam trap of the digital twin is estimated to indicate the condensate accumulation is above the predetermined threshold value, sending an alert to an operator of the industrial plant.

In an aspect, combinable with any other aspect, the plurality of steam traps accounts for from 20% to 30% of a total number of steam traps of the steam distribution network.

In an aspect, combinable with any other aspect, the computer-implemented method further includes, estimating trap conditions of all steam traps of the digital twin.

In an aspect, combinable with any other aspect, the type of steam trap is characterized by a volume, a mechanical design, a structural material, and a maximum condensate removal rate.

In an aspect, combinable with any other aspect, the computer-implemented method further includes, predicting a future trap condition of a steam trap of the digital twin based on a set of plant steam data regarding the plurality of steam traps of the industrial plant.

In an aspect, predicting the future trap condition includes estimating a time when the condensate accumulation reaches the predetermined threshold value.

An implementation described herein provides a non-transitory computer-readable medium storing instructions executable by a computer processor, where the instructions include functionality for: obtaining plant steam data regarding a plurality of steam traps of an industrial plant implementing a steam distribution network, the plant steam data including a type of steam trap, temperature, pressure, steam volumetric flow rate, condensate accumulation, condensate removal rate, and trap condition at each of the plurality of steam traps, the trap condition including information regarding whether the condensate accumulation is below a predetermined threshold value for the type of steam trap; developing a database using the plant steam data; using the database, developing a mathematical correlation that describes the condensation removal rate as a function of parameters including the type of steam trap, the temperature, the pressure, and the steam volumetric flow rate; developing a digital twin of the steam distribution network using a machine-learning model and the mathematical correlation; and estimating a trap condition of a steam trap of the digital twin based on a set of plant steam data regarding the plurality of steam traps of the industrial plant.

In an aspect, combinable with any other aspect, the instructions further include functionality for transmitting a command that adjusts one or more parameters of the steam distribution network based on the trap condition of the steam strap of the digital twin.

In an aspect, combinable with any other aspect, determining the trap condition of the steam trap of the digital twin includes classifying the trap condition of the steam trap of the digital twin into one of a plurality of categories, each category representing a different level of the condensate accumulation in the steam trap.

In an aspect, combinable with any other aspect, the instructions further include estimating a steam quality at a steam header of the steam distribution network using the digital twin and the plant steam data.

An implementation described herein provides a computer-implemented system including: a steam generator; a steam header coupled to the steam generator; a steam trap including an inlet and an outlet, the inlet being coupled to the steam header; and a steam trap manager coupled to the steam trap, the steam trap manager including a computer processor and a machine-learning model, the computer processor including a non-transitory computer readable medium storing instructions to: obtain a series of steam trap data including a type of the steam trap, temperature, pressure, steam volumetric flow rate, condensate accumulation, condensate removal rate, and trap condition of the steam trap, the trap condition including information regarding whether the condensate accumulation is below a predetermined threshold value for the type of the steam trap; develop a database from the series of steam trap data; using the database, develop a mathematical correlation between the condensation removal rate and one or more of the type of steam strap, the temperature, the pressure, and the steam volumetric flow rate; develop a digital twin of the steam trap using a machine-learning model and the mathematical correlation; and estimate a trap condition of the steam trap of the digital twin for a set of steam trap data.

In an aspect, combinable with any other aspect, the non-transitory computer readable medium stores a further instruction to adjust one or more parameters for operating the system based on the estimated trap condition of the steam trap.

In an aspect, combinable with any other aspect, the non-transitory computer readable medium stores further instructions to, after adjusting the one or more parameters, repeat the steps of obtaining the series of steam trap data, developing the database, developing the mathematical correlation, developing the digital twin, and estimating the trap condition.

In an aspect, combinable with any other aspect, the non-transitory computer readable medium stores a further instruction to estimate a steam quality at the steam header using the digital twin and the series of steam trap data.

In an aspect, combinable with any other aspect, the predetermined threshold value is from 40% to 60% of a volumetric capacity of the steam trap.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method comprising:
obtaining plant steam data regarding a plurality of steam traps of an industrial plant implementing a steam distribution network during operation of the industrial plant, the plant steam data comprising a type of steam trap, temperature, pressure, steam volumetric flow rate, condensate accumulation, condensate removal rate, and trap condition at each of the plurality of steam traps, the trap condition comprising information regarding whether the condensate accumulation is below a predetermined threshold value for the type of steam trap;
developing a database using the plant steam data;
using the database, developing a mathematical correlation that describes the condensation removal rate as a function of parameters comprising the type of steam trap, the temperature, the pressure, and the steam volumetric flow rate;
developing a digital twin of the steam distribution network using a machine-learning model and the mathematical correlation, the digital twin representing all steam straps of the steam distribution network; and
estimating, during the operation of the industrial plant, a trap condition of a steam trap of the digital twin based on a set of plant steam data regarding the plurality of steam traps of the industrial plant.

2. The computer-implemented method of claim 1, wherein the steam trap of the digital twin corresponds to one of the plurality of steam traps of the industrial plant.

3. The computer-implemented method of claim 2, further comprising validating the trap condition estimated for the digital twin with the trap condition of the one of the plurality of steam traps.

4. The computer-implemented method of claim 3, further comprising if a discrepancy between the condensate accumulation estimated in the digital twin and that of the industrial plant is 3% or greater, repeating the steps of obtaining the plant steam data, developing the database, and developing the mathematical correlation to update the digital twin.

5. The computer-implemented method of claim 1, wherein the steam trap of the digital twin corresponds to another steam trap of the industrial plant, the another steam trap being not among the plurality of steam traps of the industrial plant.

6. The computer-implemented method of claim 1, further comprising, if the trap condition of the steam trap of the digital twin is estimated to indicate the condensate accumulation is above the predetermined threshold value, sending an alert to an operator of the industrial plant.

7. The computer-implemented method of claim 1, wherein the plurality of steam traps accounts for from 20% to 30% of a total number of steam traps of the steam distribution network.

8. The computer-implemented method of claim 1, further comprising, estimating trap conditions of all steam traps of the digital twin.

9. The computer-implemented method of claim 1, wherein the type of steam trap is characterized by a volume, a mechanical design, a structural material, and a maximum condensate removal rate.

10. The computer-implemented method of claim 1, further comprising, predicting a future trap condition of a steam trap of the digital twin based on a set of plant steam data regarding the plurality of steam traps of the industrial plant.

11. The computer-implemented method of claim 10, wherein predicting the future trap condition comprises estimating a time when the condensate accumulation reaches the predetermined threshold value.

12. A non-transitory computer-readable medium storing instructions executable by a computer processor, the instructions comprising functionality for:
obtaining plant steam data regarding a plurality of steam traps of an industrial plant implementing a steam distribution network, the plant steam data comprising a type of steam trap, temperature, pressure, steam volumetric flow rate, condensate accumulation, condensate removal rate, and trap condition at each of the plurality of steam traps, the trap condition comprising information regarding whether the condensate accumulation is below a predetermined threshold value for the type of steam trap;
developing a database using the plant steam data;
using the database, developing a mathematical correlation that describes the condensation removal rate as a function of parameters comprising the type of steam trap, the temperature, the pressure, and the steam volumetric flow rate;
developing a digital twin of the steam distribution network using a machine-learning model and the mathematical correlation; and
estimating a trap condition of a steam trap of the digital twin based on a set of plant steam data regarding the plurality of steam traps of the industrial plant.

13. The non-transitory computer-readable medium of claim 12, wherein the instructions further comprise functionality for transmitting a command that adjusts one or more parameters of the steam distribution network based on the trap condition of the steam strap of the digital twin.

14. The non-transitory computer-readable medium of claim 12, wherein determining the trap condition of the steam trap of the digital twin comprises classifying the trap condition of the steam trap of the digital twin into one of a plurality of categories, each category representing a different level of the condensate accumulation in the steam trap.

15. The non-transitory computer-readable medium of claim 12, wherein the instructions further comprise estimating a steam quality at a steam header of the steam distribution network using the digital twin and the plant steam data.

16. A computer-implemented system comprising:
a steam generator;
a steam header coupled to the steam generator;
a steam trap comprising an inlet and an outlet, the inlet being coupled to the steam header; and
a steam trap manager coupled to the steam trap, the steam trap manager comprising a computer processor and a machine-learning model, the computer processor comprising a non-transitory computer readable medium storing instructions to:
obtain a series of steam trap data comprising a type of the steam trap, temperature, pressure, steam volumetric flow rate, condensate accumulation, condensate removal rate, and trap condition of the steam trap, the trap condition comprising information regarding whether the condensate accumulation is below a predetermined threshold value for the type of the steam trap;
develop a database from the series of steam trap data;
using the database, develop a mathematical correlation between the condensation removal rate and one or more of the type of steam strap, the temperature, the pressure, and the steam volumetric flow rate;
develop a digital twin of the steam trap using a machine-learning model and the mathematical correlation; and
estimate a trap condition of the steam trap of the digital twin for a set of steam trap data.

17. The computer-implemented system of claim 16, wherein the non-transitory computer readable medium stores a further instruction to adjust one or more parameters for operating the system based on the estimated trap condition of the steam trap.

18. The computer-implemented system of claim 17, wherein the non-transitory computer readable medium stores further instructions to, after adjusting the one or more parameters, repeat the steps of obtaining the series of steam trap data, developing the database, developing the mathematical correlation, developing the digital twin, and estimating the trap condition.

19. The computer-implemented system of claim 16, wherein the non-transitory computer readable medium stores a further instruction to estimate a steam quality at the steam header using the digital twin and the series of steam trap data.

20. The computer-implemented system of claim 16, wherein the predetermined threshold value is from 40% to 60% of a volumetric capacity of the steam trap.
